(19) United States
(12) Patent Application Publication
(10) Pub. No.: US 2025/0166373 A1
(43) Pub. Date: May 22, 2025

(54) RECONFIGURABLE OBSERVATION METHOD AND APPARATUS FOR ABOVEWATER OBSERVATION

(71) Applicant: ID WATER CO., LTD., Taipei (TW)

(72) Inventors: HUA TU, Taipei (TW); Hsuan-Chung HUANG, Taipei (TW); HAN-TSUNG PAN, Taipei (TW); WAN-ZHOU YU, Taipei (TW)

(21) Appl. No.: 18/768,046

(22) Filed: Jul. 10, 2024

(30) Foreign Application Priority Data
Nov. 22, 2023 (TW) 112145246

(51) Int. Cl. A01K 61/85; A01K 63/00; G06V 10/94; G06V 20/05; G06V 20/52

(52) U.S. Cl. CPC A01K 61/85; A01K 63/006; G06V 10/945; G06V 20/05; G06V 20/52

(57) ABSTRACT

The present invention discloses a method for optimizing first data from an image set of an object observed in an observation apparatus by reconfiguring at least one parameter of the observation apparatus; the observation apparatus comprises an image sensor above a water surface; the image set of the object is captured by the image sensor. The method comprises: detecting, by a processing unit, a predetermined event based on second data, wherein the second data is associated with the image set of the object; and determining, by the processing unit, an execution of an instruction based on the predetermined event, wherein the instruction comprises a reconfiguration message which reconfigures the at least one parameter of the observation apparatus corresponding to the execution of the instruction.

### CROSS-REFERENCE TO RELATED APPLICATIONS

This application claims the benefit of Taiwan patent application No. TW112145246, filed on Nov. 22, 2023, which is hereby incorporated herein by reference.

### BACKGROUND OF THE INVENTION

### 1. Field of the Invention

The present invention relates to a method for optimizing the data from the image set of the observed object, and more particularly to a method for optimizing the data from the image set of the object observed in the observation apparatus by reconfiguring the parameter(s) of the observation apparatus.

### 2. Description of Related Art

In the aquaculture, the observation apparatus observes the object (e.g., an aquatic animal set or feed) by the image set of the object (captured by the image sensor) for a subsequent analysis (e.g., an estimation of the size of the aquatic animal set) or instruction (e.g., feeding instruction). Sometimes, the image quality, reasonableness or correctness associated with the image set of the object may decrease due to an environmental variation, an improper behavior of handling the image sensor or a degrade of the component of the observation apparatus. For overcoming the above defects, the conventional method is adjusting the parameter(s) of the observation apparatus by a manual process. However, the manual process is often time-consuming, expensive and not easy to precisely adjust the parameter(s) of the observation apparatus.

Accordingly, the present invention proposes a method for optimizing the data from the image set of the object observed in the observation apparatus by reconfiguring the parameter(s) of the observation apparatus to increase the image quality, reasonableness or correctness associated with the image set of the object.

### SUMMARY OF THE INVENTION

In order to increase the image quality, reasonableness or correctness associated with the image set of the object, the present invention proposes a method for optimizing first data from the image set of the object observed in an observation apparatus by reconfiguring (dynamically configuring) at least one parameter of the observation apparatus. By reconfiguring (dynamically configuring) at least one parameter of the observation apparatus, the drawbacks resulting from an adjustment by the manual process can be avoided. Further, the optimization of the first data from the image set of the object (by reconfiguring at least one parameter of the observation apparatus) is determined based on the second data (acquired data), which comprises: detecting a predetermined event based on second data, wherein the second data is associated with the image set of the object; and determining an execution of an instruction based on the predetermined event, wherein the instruction comprises a reconfiguration message which reconfigures the at least one parameter of the observation apparatus corresponding to the execution of the instruction. Because the first data and the second data (acquired data) are both associated with the image set of the object, the optimization of the first data from the image set of the object (by reconfiguring the at least one parameter of the observation apparatus) determined based on the second data can increase the image quality, reasonableness or correctness associated with the image set of the object.

By the algorithm implemented in the computer of the present invention, the computer of the present invention performs operations described in claims or the following descriptions to optimize the data from the image set of the object observed in the observation apparatus by reconfiguring the parameter(s) of the observation apparatus.

In one embodiment, the present invention discloses a method for optimizing first data from an image set of an object observed in an observation apparatus by reconfiguring at least one parameter of the observation apparatus, wherein the observation apparatus comprises an image sensor above a water surface, wherein the image set of the object is captured by the image sensor. The method comprises: detecting, by a processing unit, a predetermined event based on second data, wherein the second data is associated with the image set of the object; and determining, by the processing unit, an execution of an instruction based on the predetermined event, wherein the instruction comprises a reconfiguration message which reconfigures the at least one parameter of the observation apparatus corresponding to the execution of the instruction.

In one embodiment, the present invention discloses a method for optimizing first data from an image set of feed observed in an observation apparatus by reconfiguring at least one parameter of the observation apparatus, wherein the feed is used to be eaten by an aquatic animal set living below a water surface, wherein the observation apparatus comprises an image sensor above the water surface, wherein the feed on the carrier and the carrier are moved from a first level above the water surface to a second level below the water surface in a first duration, and the feed on the carrier and the carrier are moved from the second level below the water surface to a third level above the water surface in a second duration, wherein the image set of the feed is captured by the image sensor when the feed is at the third level above the water surface. The method comprises: detecting, by a processing unit, a predetermined event based on second data, wherein the second data is associated with the image set of the feed; and determining, by the processing unit, an execution of an instruction based on the predetermined event, wherein the instruction comprises a reconfiguration message which reconfigures the at least one parameter of the observation apparatus corresponding to the execution of the instruction.

The detailed technology and above preferred embodiments implemented for the present invention are described in the following paragraphs accompanying the appended drawings for people skilled in the art to well appreciate the features of the claimed invention.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1 illustrates a schematic block diagram of an exemplary observation apparatus in the present invention;

FIG. 2 and FIG. 3 illustrate the image sensor unit of the observation apparatus corresponding to the method in FIG. 5 in the present invention;

FIG. 4 illustrates the associated distance applied in the observation apparatus for convenience of understanding;

FIG. 5 illustrates a method for optimizing first data from an image set of an object observed in an observation apparatus by reconfiguring (dynamically configuring) at least one parameter of the observation apparatus;

FIG. 6 illustrates a method for optimizing first data from an image set of feed observed in an observation apparatus by reconfiguring (dynamically configuring) at least one parameter of the observation apparatus; and

FIG. 7, FIG. 8 and FIG. 9 illustrate the image sensor unit of an observation apparatus corresponding to corresponding to the method in FIG. 6 in the present invention.

### DETAILED DESCRIPTION OF THE ILLUSTRATED EMBODIMENTS

The detailed explanation of the present invention is described as following. The described preferred embodiments are presented for purposes of illustrations and description and they are not intended to limit the scope of the present invention.

### Definition of the Terms

### Aquatic Animal Set

The aquatic animal set may be an aquatic animal or a plurality of aquatic animals.

### Image Set

The image set may be an image, a plurality of images or an image sequence.

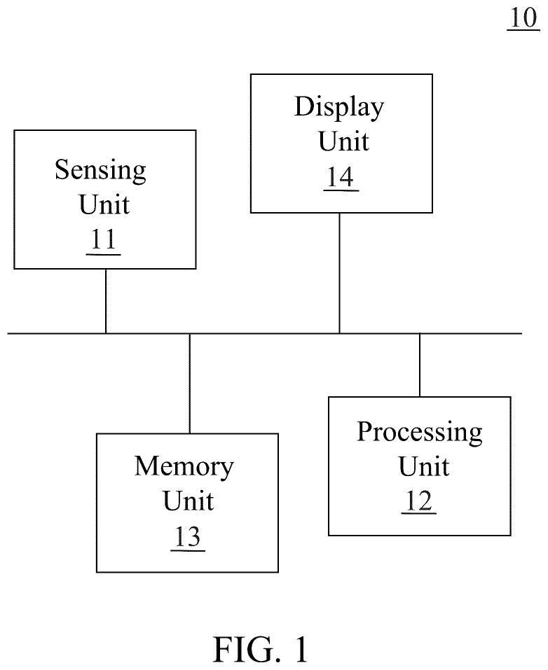

The method in the present invention may be applied in all kinds of apparatuses, such as a measurement system, a mobile device, a mobile phone, a portable device, a personal computer, a server or a combination thereof. FIG. 1 illustrates a schematic block diagram of an exemplary observation apparatus 10 in the present invention. The observation apparatus 10 may comprise a sensing unit 11, a processing unit 12, a memory unit 13, a display unit 14. The sensing unit 11 may comprise an image sensor unit 20. The image sensor unit 20 may comprise an image sensor 21, a carrier 22 and an image capture auxiliary 23. The sensing unit 11 may further comprise at least one sensor (e.g., another image sensor, an acoustic sensor, a water flow sensor or a water quality sensor) used as the data-acquiring mechanism and different from the image sensor 21. One unit may communicate with another unit in a wired or wireless way.

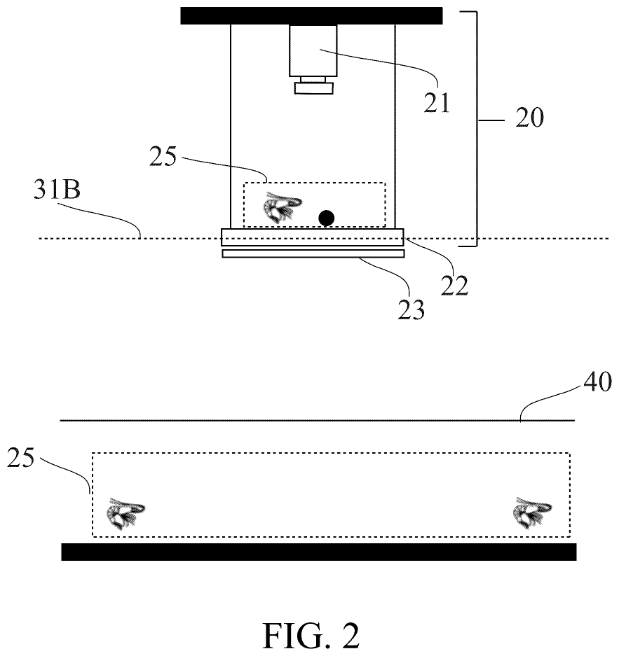

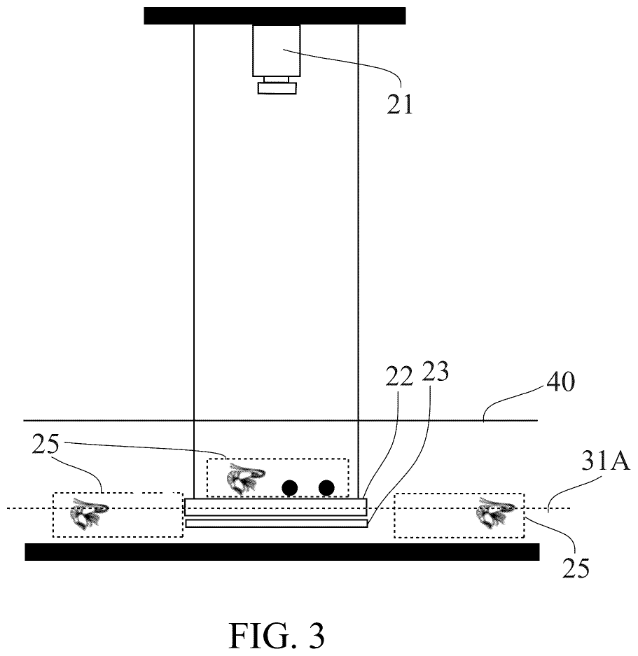

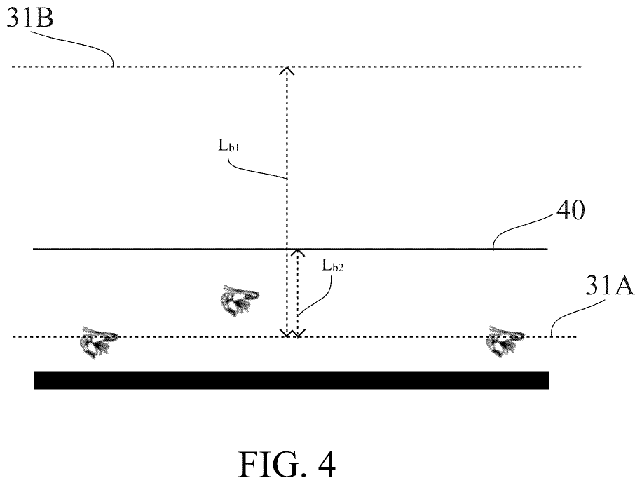

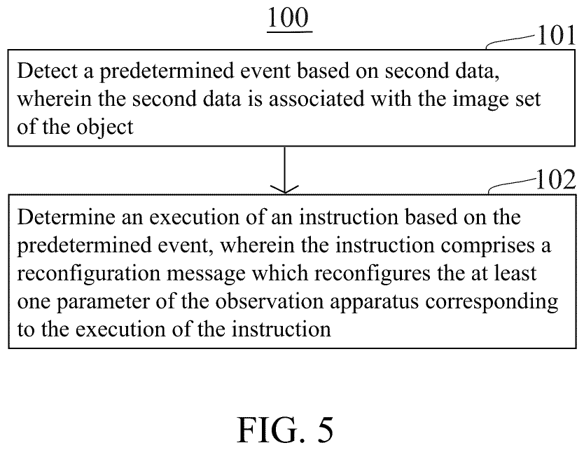

FIG. 2 and FIG. 3 illustrate the image sensor unit 20 of the observation apparatus 10 corresponding to the method 100 in FIG. 5 in the present invention. FIG. 4 illustrates the associated distance applied in the observation apparatus 10 for convenience of understanding. The image set or the data from image set of the object 25 observed in the observation apparatus 10 is optimized by reconfiguring the parameter(s) of the observation apparatus 10. The observation apparatus 10 comprises an image sensor 21 above the water surface 40. When the object 25 on the carrier 22 and the carrier 22 are moved from the first level 31A below the water surface 40 to the second level 31B above the water surface 40, the image set of the object 25 at the second level 31B above the water surface 40 is captured by the image sensor 21. Preferably, the observation apparatus 10 is applied in the aquaculture; however, the present invention is not limited to this case. The object 25 may be an aquatic animal set living below the water surface 40. The object 25 may be feed (see the black solid circle in FIG. 2 to FIG. 3). The feed can be placed below the water surface 40 and is used to be eaten by the aquatic animal set living below the water surface 40. The remain feed which is carried by the carrier 22 and moved above the water surface 40 can be used to determine the appetite of the aquatic animal set for the action of next feeding.

The observation apparatus 10 may comprise at least one first device; in one embodiment, a sensor of the sensing unit 11 may be in one first device adjacent to the sensed object and the processing unit 12 may be in another first device (e.g., a mobile device, a mobile phone, a portable device, a personal computer or a server) far from the sensed object; in another embodiment; a sensor of the sensing unit 11 and the processing unit 12 may be in a single first device. The processing unit 12 (e.g., control unit) may send a control/instruction to a sensor of the sensing unit 11 to acquire the desired data from the sensor of the sensing unit 11; for example, the control/instruction may be used to adjust the configuration parameters of a sensor of the sensing unit 11 to acquire the quality data. A sensor of the sensing unit 11 may transmit the measurement data to the processing unit 12 for the subsequent data processing/computing.

The processing unit 12 may be any suitable processing device for executing software instructions, such as processor and a central processing unit (CPU). The processing unit 12 may comprise a computing unit. The observation apparatus 10 may comprise at least one second device; a first portion (e.g., the more computing ability) of the computing unit may be in one second device (e.g., a server or a cloud server), a second portion of the computing unit may be in another second device (e.g., a mobile device, a mobile phone, a portable device or a personal computer) and a first portion of the computing unit may communicate with a second portion of the computing unit in a wired or wireless way; a first portion of the computing unit and a second portion of the computing unit may be in a single second device.

The memory unit 13 may include random access memory (RAM) and read only memory (ROM), but it is not limited to this case. The memory unit 13 may include any suitable non-transitory computer readable medium, such as ROM, CD-ROM, DVD-ROM and so on. Also, the non-transitory computer readable medium is a tangible medium. The non-transitory computer readable medium includes a computer program code which, when executed by the processing unit 12, causes the observation apparatus 10 to perform desired operations (e.g., operations listed in claims).

The display unit 14 may be a display for displaying an execution of an instruction comprising a reconfiguration message which reconfigures at least one parameter of the observation apparatus 10 corresponding to the execution of the instruction. Optionally, the related data of the instruction comprising the reconfiguration message can be are also displayed, such as the predetermined event or the second data associated with the image set of the object 25. The displaying mode may be in the form of words, a voice or an image.

The sensing unit 11, the processing unit 12, the memory unit 13 and the display unit 14 in the observation apparatus 10 may have any suitable configuration and it doesn't be described in detail therein.

FIG. 5 illustrates a method 100 for optimizing first data from an image set of an object 25 observed in an observation apparatus 10 by reconfiguring (dynamically configuring) at least one parameter of the observation apparatus 10. The observation apparatus comprises an image sensor 21 above a water surface 40. The observation apparatus 10 further comprises a carrier 22 carrying the object 25. The image set of the object 25 is captured by the image sensor 21. The method comprises:
Step 101: detect a predetermined event based on second data, wherein the second data is associated with the image set of the object 25 (by the processing unit 12); and
Step 102: determine an execution of an instruction based on the predetermined event, wherein the instruction comprises a reconfiguration message which reconfigures the at least one parameter of the observation apparatus 10 corresponding to the execution of the instruction (by the processing unit 12).

The first data from the image set of the object 25 may be the data derived from image set of the object 25. The first data from the image set of the object 25 may be the image set of the object 25.

The optimization of the first data from the image set of the object 25 may be an improvement of the image quality associated with the image set of the object 25. The image quality associated with the image set of the object 25 may be the image quality of the image set of the object 25. The image quality associated with the image set of the object 25 may be the image quality of the data derived from the image set of the object 25 (e.g., an estimation of the size of the object 25).

The optimization of the first data from the image set of the object 25 may be an improvement of reasonableness or correctness associated with the image set of the object 25. For example, there should be three aquatic animals in the image of the object 25 but there is only one aquatic animal in the image of the object 25; therefore, the reasonableness or correctness associated with the image of the object 25 should be modified. For example, the image of the object 25 should be acquired from the object 25 in the state A1 but the image of the object 25 is acquired from the object 25 in the state A2; therefore, the reasonableness or correctness associated with of the image of the object 25 should be modified. The reasonableness or correctness associated with the image set of the object 25 may be the reasonableness or correctness of the image set of the object 25. The reasonableness or correctness associated with the image set of the object 25 may be the reasonableness or correctness of the data derived from the image set of the object 25 (e.g., an estimation of the size of the object 25).

The second data (acquired data) is associated with the image set of the object 25. In one embodiment, the first data from the image set of the object 25 may be used as the second data (acquired data). If the second data (acquired data) is associated with “the image quality associated with the image set of the object 25”, the optimization of the first data from the image set of the object 25 is an improvement of “the image quality associated with the image set of the object 25”. If the second data (acquired data) is associated with “the reasonableness or correctness associated with the image set of the object 25”, the optimization of the first data from the image set of the object 25 is an improvement of “the reasonableness or correctness associated with the image set of the object 25”. Because the first data and the second data are both associated with the image set of the object 25, the optimization of the first data from the image set of the object 25 can be determined based on the second data so as to increase the image quality, the reasonableness or correctness associated with the image set of the object 25.

Further, the optimization of the first data from the image set of the object 25 can be performed by reconfiguring (dynamically configuring) at least one parameter of the observation apparatus 10 based on the second data associated with the image set of the object 25.

Specifically, a predetermined event is detected based on the second data and then the optimization of the first data from the image set of the object 25 can be performed by an execution of an instruction determined based on the predetermined event. The instruction comprises a reconfiguration message which reconfigures the at least one parameter of the observation apparatus 10 corresponding to the execution of the instruction.

The reconfigured parameter(s) of the observation apparatus 10 corresponding to the execution of the instruction may comprise any parameter of the observation apparatus 10 which can be adjusted to optimize the first data from the image set of the object 25 observed in the observation apparatus 10. The reconfigured parameter(s) of the observation apparatus 10 corresponding to the execution of the instruction may comprise the parameter(s) of the component of the observation apparatus 10; for example, the component of the observation apparatus 10 may be the image sensor unit 20 and the parameter(s) of the image sensor unit 20 may comprise at least one of a brightness of a light source of the image sensor 21, a capturing angle of the image sensor 21, a magnification of the image sensor 21, a pixel number to capture the image set of the object 25, a distance between the carrier 22 and the image sensor 21, a color of the carrier 22, a color of the image capture auxiliary 23, a moving parameter of the carrier 22, the time when the aquatic animal set is captured by the movement of the carrier 22, the location where the carrier 22 is moved. Besides, the parameter(s) of one of at least one sensor different the image sensor 21 in the sensing unit 11, the processing unit 12 and the memory unit 13 may be used as the reconfigured parameter(s) of the observation apparatus 10 corresponding to the execution of the instruction.

The second data associated with the image set of the object 25 may be acquired by a (corresponding) data-acquiring mechanism. The data-acquiring mechanism may comprise the hardware (e.g., sensor), the software (e.g., algorithm or computer program code) or a combination of the hardware and the software.

For optimizing the first data from the image set of the object 25 observed in the observation apparatus 10 by reconfiguring (dynamically configuring) at least one parameter of the observation apparatus 10, the image quality of the image set of the object 25 is an important metric. The predetermined event may be whether the image quality associated with the image set of the object 25 is less than a predetermined criterion X1 and the instruction may be executed for improve the image quality. The predetermined event may be to what degree the image quality associated with the image set of the object 25 becomes good and the instruction may be whether to activate an image quality enhancement mechanism. The second data (associated with the image set of the object 25) may be the image quality associated with the image set of the object 25. The data-acquiring mechanism be executed by any suitable method. When the image quality associated with the image set of the object 25 captured by the image sensor 21 is more than a predetermined criterion X2, the image quality enhancement mechanism may be deactivated (e.g., reduce the power consumption). When the image quality associated with the image set of the object 25 captured by the image sensor 21 is less than a predetermined criterion X3, the image quality enhancement mechanism may be activated (e.g., improve the image quality).

In one embodiment, the image quality enhancement mechanism may be disposed in the image sensor 21. For example, the image sensor 21 has a two-dimensional image-capturing mode and a three-dimensional image-capturing mode. Condition 1: the components (e.g., the aquatic animal set and the feed) of the object 25 don't overlap; when the image quality associated with the image set of the object 25 captured by the image sensor 21 operated in the two-dimensional image-capturing mode is more than a predetermined criterion X2, the three-dimensional image-capturing mode (i.e. the image quality enhancement mechanism) of the image sensor 21 can be deactivated (e.g., reduce the power consumption). Condition 2: the components of the object overlap; when the image quality associated with the image set of the object 25 captured by the image sensor 21 operated in the two-dimensional image-capturing mode is less than a predetermined criterion X3, the three-dimensional image-capturing mode (i.e. the image quality enhancement mechanism) of the image sensor 21 can be activated to improve the image quality associated with the image set of the object 25.

In one embodiment, the image quality enhancement mechanism may be disposed in another sensor different from the image sensor 21. Another sensor may be an image sensor or an acoustic sensor. For example, when the image quality associated with the image set of the object 25 captured by the image sensor 21 is more than a predetermined criterion X2, another sensor can be deactivated (e.g., reduce the power consumption). For example, when the image quality associated with the image set of the object 25 captured by the image sensor 21 is less than a predetermined criterion X3, another sensor can be activated to improve the image quality associated with the image set of the object 25.

In one embodiment, the image quality enhancement mechanism may be disposed in the processing unit 12 used as a control unit.

The predetermined event may be to what degree an image quality associated with the image set of the object 25 becomes good and the instruction may be reconfiguring the at least one parameter of the observation apparatus 10. The at least one parameter of the observation apparatus 10 may comprise at least one of a brightness of a light source of the image sensor 21, a capturing angle of the image sensor 21, a magnification of the image sensor 21, a pixel number to capture the image set of the object 25 and a distance between the carrier 22 and the image sensor 21. The second data (associated with the image set of the object 25) may be the image quality associated with the image set of the object 25. The data-acquiring mechanism be executed by any suitable method.

The predetermined event may be a size of the object 25, and the instruction may be reconfiguring the at least one parameter of the observation apparatus 10. The at least one parameter of the observation apparatus 10 may comprise at least one of a brightness of a light source of the image sensor 21, a capturing angle of the image sensor 21, a magnification of the image sensor 21, a pixel number to capture the image set of the object 25 and a distance between the carrier 22 and the image sensor 21. The second data (associated with the image set of the object 25) may be an image of the object 25. The data-acquiring mechanism may be executed by the image sensor 21. The data-acquiring mechanism may be executed by another image sensor different from the image sensor 21.

In one embodiment, the parameter of the observation apparatus 10 is the distance between the carrier 22 and the image sensor 21. The distance between the carrier 22 and the image sensor 21 can be adjusted for optimizing the image quality or the image obviousness of the image set of the object 25.

In one embodiment, the parameter of the observation apparatus 10 is a pixel number to capture the image set of the object 25. Specifically, if the size of the object 25 is less, the more pixel number to capture the image set of the object 25 is needed for having a threshold of the image quality or the image obviousness of the image set of the object 25. If the pixel number to capture the image set of the object 25 is more, the image quality or the image obviousness of the image set of the object 25 is better. However, the more pixel number to capture the image set of the object 25 may lead to a waste of a computing/memory resource. Therefore, the pixel number to capture the image set of the object 25 needs to be controlled based on the size of the object 25.

The first pixel number to capture the image set of the object 25 may be acquired by summing the second pixel numbers of the image portions (the second pixel number is less than the first pixel number). Specifically, the image set of the object 25 has the first pixel number; the image set of the object 25 comprise a plurality of image portions (two adjacent image portions may overlap or may not overlap); each of image portions is captured by the image sensor 21 having the second pixel number. In other word, after each of image portions is captured by the image sensor 21 having the second pixel number, the image portions each of which has the second pixel number are combined into the image set of the object 25 having the first pixel number. In some case, if the image sensor 21 having the first pixel number is expensive or is not easy to acquire, this method can be used.

The first pixel number can be associated with a number of image portions. For example, if each of the image portions has the same second pixel number, the first pixel number is a product of the second pixel number and the number of image portions. In one embodiment, the predetermined event is a size of the object 25, and the instruction is reconfiguring the number of image portions.

### Type I

The object 25 is an aquatic animal set (e.g., shrimp or fish) living below the water surface 40. The aquatic animal set living below the water surface 40 is captured by the movement of the carrier 22. The movement of the carrier 22 is performed by moving the carrier 22 (along a path L_{b1}) from the first level 31A below the water surface 40 to the second level 31B above the water surface 40 (in a duration T_{b}). The carrier 22 may be moved by any suitable method. For example, the carrier 22 is connected to at least one rope and the carrier 22 may be moved by adjusting the pulled length of each of at least one rope. The pulled length of each of at least one rope can be adjusted by the processing unit 12 used as a control unit; however, the present invention is not limited to this cause. The image set of the object 25 is captured by the image sensor 21 when the object 25 is at the second level 31B above the water surface 40. The carrier 22 is at the first level 31A below the water surface 40 to capture the aquatic animal set living below the water surface 40, and the carrier 22 and the aquatic animal set living below the water surface 40 are moved to the second level 31B above the water surface 40 such that the aquatic animal set living below the water surface 40 is capable of being observed above the water surface 40.

In one embodiment, before the carrier 22 is at the first level 31A below the water surface 40, the carrier 22 may be above the water surface 40 (not shown); in other words, the carrier 22 may be moved from another level above the water surface 40 to the first level 31A below the water surface 40.

The predetermined event may be to what degree the aquatic animal set escapes from the carrier 22 when the carrier 22 is moved from the first level 31A below the water surface 40 to the second level 31B above the water surface 40 and the instruction may be controlling a moving parameter of the carrier 22. The predetermined event may be to what degree the aquatic animal set escapes from the carrier 22 when the carrier 22 is moved from the water surface 40 to the second level 31B above the water surface 40 (in a duration T_{c}). The second data (associated with the image set of the object 25) may be an image sequence of the aquatic animal set and the carrier 22 in the duration T_{b} or the duration T_{c}. The data-acquiring mechanism may be executed by the image sensor 21. The data-acquiring mechanism may be executed by another image sensor different from the image sensor 21. Specifically, if the aquatic animal set escapes from the carrier 22, the image set of the object 25 may be incorrect so as to decrease a precision of the subsequent image analysis, such as the average weight of the aquatic animal set or the overall weight of the aquatic animal set below the water surface 40. By controlling the moving parameter of the carrier 22, to the degree the aquatic animal set escapes from the carrier 22 can be mitigated. The moving parameter may be a moving velocity or an acceleration. For example, the less the moving velocity of the carrier 22 is, the less the number of the aquatic animal set escaping from the carrier 22 is.

The predetermined event may be to what degree water below the water surface 40 flows in each location of the path L_{b2} from the first level 31A below the water surface 40 to the water surface 40 and the instruction may be whether to change the time when the aquatic animal set is captured by the movement of the carrier 22. The path L_{b2} is a portion of the path L_{b1}. The second data (associated with the image set of the object 25) may be water flow data of the water below the water surface 40. The data-acquiring mechanism may be executed by a water flow sensor. Specifically, if water flows rapidly at a location of the path L_{b2}, the carrier 22 may not be moved along the path L_{b1} successfully such that the image set of the object 25 may be incorrect so as to decrease a precision of the subsequent image analysis. By changing the time when the aquatic animal set is captured by the movement of the carrier 22, the carrier 22 can be moved along the path L_{b1} successfully. For example, the predetermined time when the aquatic animal set is captured by the movement of the carrier 22 is the time Tₓ₁; if water flows rapidly in at least one location of the path L_{b2} at the time Tₓ₁ and water flows smoothly in each location of the path L_{b2} at the time T_{y1} later than Tₓ₁, the time when the aquatic animal set is captured by the movement of the carrier 22 can be changed from the time Tₓ₁ to the time T_{y1}.

The predetermined event may be abnormal quality of water in a first location of the path L_{b2} from the first level 31A below the water surface 40 to the water surface 40 and the instruction may be moving the carrier 22 to a second location to capture the aquatic animal set. The path L_{b2} is a portion of the path L_{b1}. The second data (associated with the image set of the object 25) may be water quality data of the water below the water surface 40. The data-acquiring mechanism may be executed by a water quality sensor. The second location may be in the path L_{b2}. The second location may be in an extend path of the path L_{b2}. Specifically, abnormal water quality exists in a first location of the path L_{b2} means the aquatic animal set can't live in the first location of the path L_{b2} and the aquatic animal set may live in a second location (different from the first location), so the carrier 22 can be moved to a second location to captured the aquatic animal set.

In one embodiment, the predetermined event may be abnormal quality of water in a first location of the path L_{b2} from the first level 31A below the water surface 40 to the water surface 40 and the instruction may be changing the time when the aquatic animal set is captured by the movement of the carrier 22. For example, the predetermined time when the aquatic animal set is captured by the movement of the carrier is the time Tₓ₂; if abnormal quality exists in a first location of the path L_{b2} at the time Tₓ₂ and no abnormal quality exist in each location of the path L_{b2} at the time T_{y2} later than Tₓ₂, the time when the aquatic animal set is captured by the movement of the carrier 22 can be changed from the time Tₓ₂ to the time T_{y2}.

The predetermined event may be whether the aquatic animal set is in an ecdysis state (whether the ecdysis happens or not) and the instruction may be changing the time when the aquatic animal set is captured by the movement of the carrier 22. The second data (associated with the image set of the object 25) may be data associated with an ecdysis of the aquatic animal set. The data-acquiring mechanism be executed by any suitable method. Taking estimating the appetite of the aquatic animal set for example; the appetite of the aquatic animal set is generally determined from the image set of the aquatic animal set in the non-ecdysis state because the aquatic animal set in the ecdysis state is not inclined to eat feed. By changing the time when the aquatic animal set is captured by the movement of the carrier 22, a precision of an estimation of the appetite of the aquatic animal set can be increased. For example, the predetermined time when the aquatic animal set is captured by the movement of the carrier 22 is time Tₓ₃; if the aquatic animal set is in the ecdysis state at the time Tₓ₃ and the aquatic animal set is in the non-ecdysis state at the time T_{y3} later than Tₓ₃, the time when the aquatic animal set is captured by the movement of the carrier 22 can be changed from the time Tₓ₃ to the time T_{y3}.

### Type II

The object 25 on the carrier 22 and the carrier 22 are moved from the first level 31A below the water surface 40 to the second level 31B above the water surface 40. The image set of the object 25 is captured by the image sensor 21 when the object 25 is at the second level 31B above the water surface 40. The object 25 may comprise at least one of an aquatic animal set living below the water surface 40, a portion (e.g., viscus) of the aquatic animal set living below the water surface 40 and feed. The second data (associated with the image set of the object 25) may be further associated with the carrier 22.

The predetermined event may be a location where the object 25 is on the carrier 22 and the instruction may be modifying an estimation of the actual size of the object 25. The second data (associated with the image set of the object 25) may be an image of the aquatic animal set and the carrier 22. The data-acquiring mechanism may be executed by the image sensor 21. Specifically, the object 25 of the same actual size at the different location on the carrier 22 may have a different image size. For example, at the location L1 on the carrier 22, the actual length of 1 mm may correspond to the image length of 0.9 mm and the adjusting factor is 10/9; at the location L2 different from the location L1 on the carrier 22, the actual length of 1 mm may correspond to the image length of 0.8 mm and the adjusting factor is 10/8. Therefore, an estimation of the actual length of the object 25 can be modified based on the location where the object 25 is on the carrier 22. Further, the object 25 of the different actual size at the same location on the carrier 22 may have a different adjusting factor. For example, at the same location on the carrier 22, the actual length of 1 mm may correspond to the image length of 0.9 mm and the adjusting factor is 10/9, the actual length of 0.5 mm may correspond to the image length of 0.4 mm and the adjusting factor is 5/4. Therefore, an estimation of the actual length (size) of the object 25 can be modified based on the location where the object 25 is on the carrier 22 and the image length (size) of the image set of the object 25. The are some ways to perform the modification. For example, for the same/different image size, the adjusting factor at each location on the carrier 22 may be collected as a rule table. The rule table can be applied in the modification algorithm.

The predetermined event may be an optical event associated with the carrier 22 and the instruction may be reconfiguring the at least one parameter of the observation apparatus 10. The second data (associated with the image set of the object 25) may be associated with an optical property (e.g., dirtiness or water stagnancy) of the carrier 22. The data-acquiring mechanism may be executed by the image sensor 21. In one embodiment, the optical event associated with the carrier 22 is a degree of a dirtiness of the carrier 22. In one embodiment, the optical event associated with the carrier 22 is a degree of an overlap of the object 25 on the carrier 22 and a dirty region of the carrier 22. In one embodiment, the optical event associated with the carrier 22 is a degree of water stagnancy on the carrier 22. In one embodiment, the optical event associated with the carrier 22 is a degree of an overlap of the object 25 on the carrier 22 and water stagnancy on the carrier 22. In one embodiment, the optical event associated with the carrier 22 is a color of the carrier 22.

The predetermined event may be an optical event associated with the object 25 and the instruction may be reconfiguring the at least one parameter of the observation apparatus 10. The second data (associated with the image set of the object 25) may be associated with an optical property (e.g., water stagnancy) of the object 25. The data-acquiring mechanism may be executed by the image sensor 21. In one embodiment, the optical event associated with the object 25 is a degree of water stagnancy on the object 25 on the carrier 22. In one embodiment, the optical event associated with the object 25 may be a color of the object 25.

Further speaking, when the carrier 22 is moved from the first level 31A below the water surface 40 to the second level 31B above the water surface 40, the object 25/carrier 22 may be moistened due to the contact with the water or the carrier 22 may be dirtied due to the contact with the dirtiness source in the water such that the optical event associated with the object 25/carrier 22 may occur. In one example, the carrier 22 may have many grids such that the water can exit the carrier 22 via the grids when the carrier 22 is moved to the second level 31B above the water surface 40 for optimizing an observation of the object 25. However, the grids of the carrier 22 may be easily moistened or dirtied. The moistened/dirtied carrier 22 may affect an observation of the object 25. For example, light reflection may result from the moistened/dirtied carrier 22 and thus it is not easy to observe the object 25; therefore, reconfiguring the at least one parameter of the observation apparatus 10 is helpful for the image quality of the image set of the object 25. The light reflection may result from the moistened object 25; therefore, reconfiguring the at least one parameter of the observation apparatus 10 is also helpful for the image quality of the image set of the object 25.

The reconfiguring parameter of the observation apparatus 10 may comprise at least one of a brightness of a light source of the image sensor 21, a capturing angle of the image sensor 21, a magnification of the image sensor 21, a pixel number to capture the image set of the object 25 and a distance between the carrier 22 and the image sensor 21. However, the present invention is not limited to this case.

The observation apparatus 10 may further comprise an image capture auxiliary 23. The image capture auxiliary 23 may be disposed in any suitable position. Preferably, the carrier 22 is between the image sensor 21 and the image capture auxiliary 23. The image capture auxiliary 23 may be a sheet, a plate or any other suitable object. The image capture auxiliary 23 may be fixed to the carrier 22.

The predetermined event may be an optical event associated with the carrier 22 and the instruction may be reconfiguring the at least one parameter of the observation apparatus 10; the reconfiguring parameter of the observation apparatus 10 may further comprise a color of the image capture auxiliary 23. The color of the image capture auxiliary 23 may compensate for the optical defect result from the optical event associated with the carrier 22 to improve the image quality of the image set of the object 25.

The predetermined event may be an optical event set comprising a first optical event associated with the carrier 22 and a second optical event associated with the object 25, and the instruction may be reconfiguring the at least one parameter of the observation apparatus 10. In one embodiment, the second optical event associated with the object 25 is a first color of the object 25 and the instruction is reconfiguring a second color of the image capture auxiliary 23. The color of the image capture auxiliary 23 may compensate for the optical defect result from a combination of the optical event associated with the carrier 22 and the color of the object 25 to improve the image quality of the image set of the object 25.

In another embodiment, the first optical event associated with the carrier 22 is a first color of the carrier 22, the second optical event associated with the object 25 is a second color of the object 25 and the instruction is reconfiguring a third color of the image capture auxiliary 23. The color of the image capture auxiliary 23 may compensate for the optical defect result from a combination of the color of the carrier 22 and the color of the object 25 to improve the image quality of the image set of the object 25.

When each of the degree of a dirtiness of the carrier 22 and the degree of water stagnancy on the carrier 22 is more than a threshold such that it is hard/it doesn't work that reconfigure the at least one parameter (e.g., the color of the image capture auxiliary 23) of the observation apparatus 10 to improve the image quality of the image set of the object 25, it is suggested that clean the carrier 22 and reuse the cleaned carrier 22.

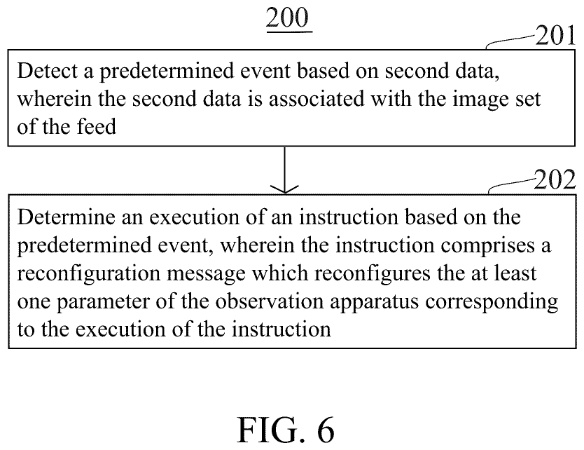

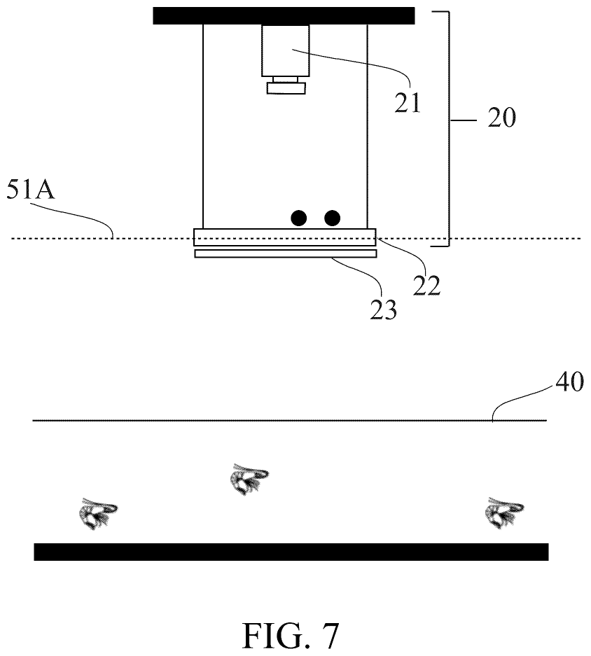

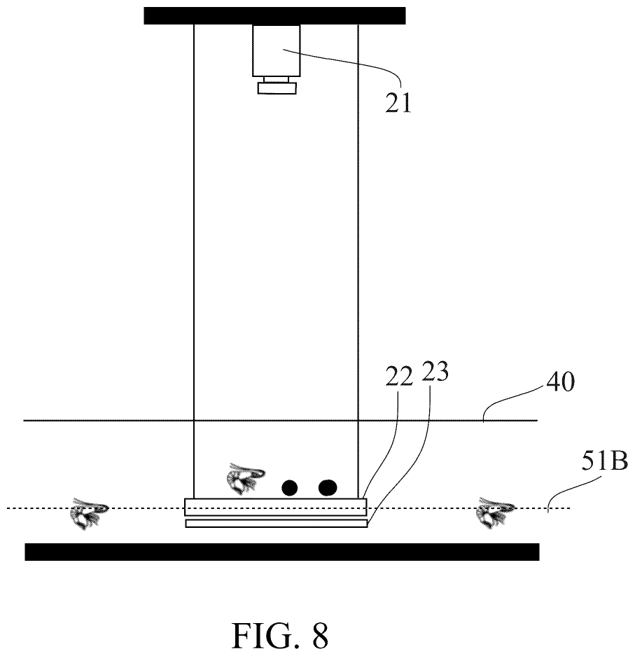

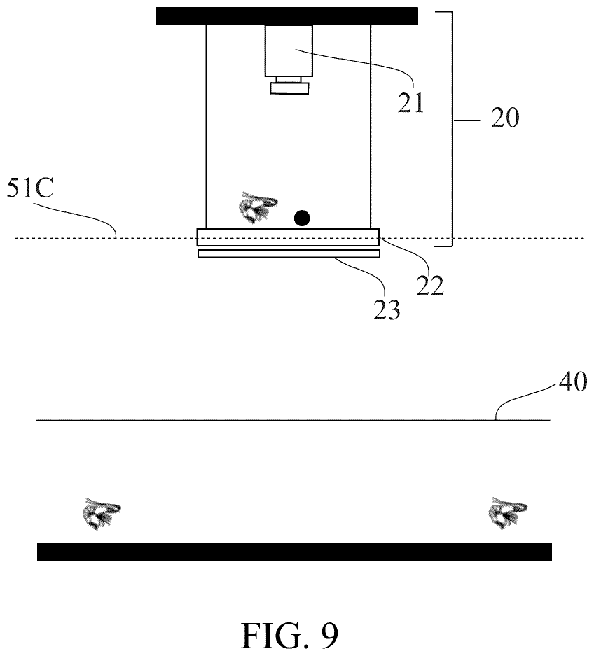

FIG. 6 illustrates a method 200 for optimizing first data from an image set of feed observed in an observation apparatus 10 by reconfiguring (dynamically configuring) at least one parameter of the observation apparatus 10. FIG. 7, FIG. 8 and FIG. 9 illustrate the image sensor unit 20 of the observation apparatus 10 corresponding to corresponding to the method 200 in FIG. 6 in the present invention. The feed (see the black solid circle in FIG. 7, FIG. 8 and FIG. 9) is used to be eaten by an aquatic animal set living below the water surface 40. The observation apparatus 10 comprises an image sensor 21 above the water surface 40 and a carrier 22 carrying the feed. The feed on the carrier 22 and the carrier 22 are moved from a first level 51A above the water surface 40 to a second level 51B below the water surface 40 in a first duration, and the feed on the carrier 22 and the carrier 22 are moved from the second level 51B below the water surface 40 to a third level 51C above the water surface 40 in a second duration. The carrier 22 may be moved by any suitable method. For example, the carrier 22 is connected to at least one rope and the carrier 22 may be moved by adjusting the pulled length of each of at least one rope. The pulled length of each of at least one rope can be adjusted by the processing unit 12 used as a control unit; however, the present invention is not limited to this cause. The image set of the feed is captured by the image sensor 21 when the feed is at the third level 51C above the water surface 40. The method comprises:
Step 201: detect a predetermined event based on second data, wherein the second data is associated with the image set of the feed (by the processing unit 12); and
Step 202: determine an execution of an instruction based on the predetermined event, wherein the instruction comprises a reconfiguration message which reconfigures the at least one parameter of the observation apparatus 10 corresponding to the execution of the instruction (by the processing unit 12).

The related description of “the first data from the image set of the feed”, “the optimization of the first data from the image set of the feed” and “the second data (acquired data) associated with the image set of the feed” is the same as the related description of “the first data from the image set of the object 25”, “the optimization of the first data from the image set of the object 25” and “the second data (acquired data) associated with the image set of the object 25”, so it doesn't be described again herein.

After the feed on the carrier 22 and the carrier 22 are moved from the first level 51A above the water surface 40 to the second level 51B below the water surface 40, the feed is eaten by the aquatic animal set living below the water surface 40. Then, the remain feed on the carrier 22 and the carrier 22 are moved from the second level 51B below the water surface 40 to the third level 51C above the water surface 40 for an observation of the remain feed. The third level 51C may be the same as the first level 51A. The third level 51C may be different from the first level 51A. The remain feed on the carrier 22 can be used for the subsequent analysis; for example, it can be used to determine the appetite of the aquatic animal set for the action of next feeding.

The predetermined event may be a sinking status of the feed below the water surface 40 in a third duration when the feed (on the carrier 22) and the carrier 22 above the water surface 40 are moved below the water surface 40 and the instruction may be controlling a moving parameter of the carrier 22. The sinking status of the feed may be determined relative to a movement of the carrier 22. The second data (associated with the image set of the feed) may be an image sequence of the feed and the carrier 22 in the third duration. The data-acquiring mechanism may be executed by the image sensor 21. The data-acquiring mechanism may be executed by another image sensor different from the image sensor 21. Specifically, when the feed (on the carrier 22) and the carrier 22 above the water surface 40 are moved below the water surface 40 in the first duration, the feed may be separated from the carrier 22 (because of the buoyancy of the water) such that the feed carried by the carrier 22 can't be fully provided to the aquatic animal set below the water surface 40. It will lead to an imprecision of an estimation of the remain feed and the appetite of the aquatic animal set, so the action of next feeding can't be effective determined. By controlling the moving parameter of the carrier 22, the feed can be not separated from the carrier 22 such that the feed carried by the carrier 22 can be fully provided to the aquatic animal set below the water surface 40. It will increase a precision of an estimation of the remain feed and the appetite of the aquatic animal set, so the action of next feeding can be effective determined. The moving parameter may be a moving velocity or an acceleration. For example, the less the moving velocity of the carrier 22 is, the less a degree of separation between the feed and the carrier 22 is.

The predetermined event may be an amount of the feed (on the carrier 22) at the first level 51A above the water surface 40 and the instruction may be controlling a volume of a fluid combined with the feed (on the carrier 22) at the first level 51A above the water surface 40. The feed has a first density and the fluid has a second density more than the first density. The fluid may be any suitable fluid, such as water. The combination of the fluid and the feed may be performed by any suitable method; for example, water is sprayed on the feed. The second data (associated with the image set of the feed) may be an image of the feed (on the carrier 22) at the first level 51A above the water surface 40. The data-acquiring mechanism may be executed by the image sensor 21. The data-acquiring mechanism may be executed by another image sensor different from the image sensor 21. Specifically, when the feed on the carrier 22 and the carrier 22 above the water surface 40 are moved below the water surface 40 in the first duration, the feed may be separated from the carrier 22 (because of the buoyancy of the water) such that the feed carried by the carrier 22 can't be fully provided to the aquatic animal set below the water surface 40. It will lead to an imprecision of an estimation of the remain feed and the appetite of the aquatic animal set, so the action of next feeding can't be effective determined. By combing the fluid (having the second density more than the first density) with the feed (having the first density), the feed combined with the fluid can sink below the water surface 40 and the feed is not easy to be separated from the carrier 22 such that the feed carried by the carrier 22 can be fully provided to the aquatic animal set below the water surface 40. It will increase a precision of an estimation of the remain feed and the appetite of the aquatic animal set, so the action of next feeding can be effective determined.

Further, if the volume of the fluid combined with the feed is less, the feed may be not fully combined with the fluid and thus a portion of the feed which is not combined with the fluid may not sink below the water surface 40; if the volume of the fluid combined with the feed is more, the feed may be excessively moistened such than the feed may deteriorate and is not suitable for the aquatic animal set living below the water surface 40 to eat. Therefore, the volume of the fluid combined with the feed (on the carrier 22 at the first level 51A above the water surface 40) needs to be controlled based on the amount of the feed (on the carrier 22 at the first level 51A above the water surface 40).

Besides, the method of combining the fluid with the feed (on the carrier 22 at the first level 51A above the water surface 40) may be performed based on a distribution of the feed (on the carrier 22 at the first level 51A above the water surface 40). In one embodiment, the volume of the fluid combined with the feed (on the carrier 22 at the first level 51A above the water surface 40) needs to be controlled based on a distribution of the feed (on the carrier 22 at the first level 51A above the water surface 40).

The above disclosure is related to the detailed technical contents and inventive features thereof. People skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for optimizing first data from an image set of an object observed in an observation apparatus by reconfiguring at least one parameter of the observation apparatus, wherein the observation apparatus comprises an image sensor above a water surface, wherein the image set of the object is captured by the image sensor, the method comprising:
detecting, by a processing unit, a predetermined event based on second data, wherein the second data is associated with the image set of the object; and
determining, by the processing unit, an execution of an instruction based on the predetermined event, wherein the instruction comprises a reconfiguration message which reconfigures the at least one parameter of the observation apparatus corresponding to the execution of the instruction.

2. The method according to claim 1, wherein the predetermined event is whether an image quality associated with the image set of the object is less than a predetermined criterion.

3. The method according to claim 1, wherein the predetermined event is to what degree an image quality associated with the image set of the object becomes good, wherein the instruction is whether to activate an image quality enhancement mechanism.

4. The method according to claim 1, wherein the predetermined event is to what degree an image quality associated with the image set becomes good, wherein the instruction is reconfiguring the at least one parameter of the observation apparatus.

5. The method according to claim 4, wherein the observation apparatus further comprises a carrier carrying the object, wherein the at least one parameter of the observation apparatus comprises at least one of a brightness of a light source of the image sensor, a capturing angle of the image sensor, a magnification of the image sensor, a pixel number to capture the image set of the object and a distance between the carrier and the image sensor.

6. The method according to claim 1, wherein the image set of the object has a first pixel number, wherein the image set of the object comprises a plurality of image portions, wherein each of the plurality of image portions is captured by the image sensor having a second pixel number, wherein the first pixel number is associated with a number of the plurality of image portions, wherein the predetermined event is a size of the object, wherein the instruction is reconfiguring the number of the plurality of image portions.

7. The method according to claim 1, wherein the observation apparatus further comprises a carrier carrying the object, wherein the object is an aquatic animal set living below the water surface, wherein the aquatic animal set living below the water surface is captured by a movement of the carrier, wherein the movement of the carrier is performed by moving the carrier from a first level below the water surface to a second level above the water surface, wherein the image set of the object is captured by the image sensor when the object is at the second level above the water surface, wherein the carrier is at the first level below the water surface to capture the aquatic animal set living below the water surface, and the carrier and the aquatic animal set living below the water surface are moved to the second level above the water surface such that the aquatic animal set living below the water surface is capable of being observed above the water surface.

8. The method according to claim 7, wherein the movement of the carrier is performed by moving the carrier from the first level below the water surface to the second level above the water surface in a duration, wherein the predetermined event is to what degree the aquatic animal set escapes from the carrier when the carrier is moved from the first level below the water surface to the second level above the water surface, wherein the instruction is controlling a moving parameter of the carrier, wherein the second data is an image sequence of the aquatic animal set and the carrier in the duration.

9. The method according to claim 7, wherein the movement of the carrier is performed by moving the carrier along a first path from the first level below the water surface to the second level above the water surface, wherein the predetermined event is to what degree water below the water surface flows in each location of a second path from the first level below the water surface to the water surface, wherein the instruction is whether to change the time when the aquatic animal set is captured by the movement of the carrier, wherein the second path is a portion of the first path, wherein the second data is water flow data of the water below the water surface.

10. The method according to claim 7, wherein the movement of the carrier is performed by moving the carrier along a first path from the first level below the water surface to the second level above the water surface, wherein the predetermined event is abnormal quality of water in a first location of a second path from the first level below the water surface to the water surface, wherein the instruction is moving the carrier to a second location to capture the aquatic animal set, wherein the second path is a portion of the first path, wherein the second data is water quality data of the water below the water surface.

11. The method according to claim 7, wherein the movement of the carrier is performed by moving the carrier along a first path from the first level below the water surface to the second level above the water surface, wherein the predetermined event is abnormal quality of water in a first location of a second path from the first level below the water surface to the water surface, wherein the instruction is changing the time when the aquatic animal set is captured by the movement of the carrier, wherein the second path is a portion of the first path, wherein the second data is water quality data of the water below the water surface.

12. The method according to claim 7, wherein the predetermined event is whether the aquatic animal set is in an ecdysis state, wherein the instruction is changing the time when the aquatic animal set is captured by the movement of the carrier, wherein the second data is data associated with an ecdysis of the aquatic animal set.

13. The method according to claim 1, wherein the observation apparatus further comprises a carrier carrying the object, wherein the object on the carrier and the carrier are moved from a first level below the water surface to a second level above the water surface, wherein the image set of the object is captured by the image sensor when the object is at the second level above the water surface.

14. The method according to claim 13, wherein the object comprises at least one of an aquatic animal set living below the water surface, a portion of the aquatic animal set living below the water surface and feed.

15. The method according to claim 13, wherein the predetermined event is a location where the object is on the carrier, wherein the instruction is modifying an estimation of an actual size of the object.

16. The method according to claim 13, wherein the predetermined event is a location where the object is on the carrier and an image size of the image set of the object, wherein the instruction is modifying an estimation of an actual size of the object.

17. The method according to claim 1, wherein the observation apparatus further comprises a carrier carrying the object, wherein the predetermined event is an optical event associated with the carrier, wherein the instruction is reconfiguring the at least one parameter of the observation apparatus.

18. The method according to claim 17, wherein the optical event associated with the carrier is a degree of a dirtiness of the carrier.

19. The method according to claim 17, wherein the optical event associated with the carrier is a degree of an overlap of the object on the carrier and a dirty region of the carrier.

20. The method according to claim 17, wherein the optical event associated with the carrier is a degree of water stagnancy on the carrier.

21. The method according to claim 17, wherein the optical event associated with the carrier is a degree of an overlap of the object on the carrier and water stagnancy on the carrier.

22. The method according to claim 17, wherein the optical event associated with the carrier is a color of the carrier.

23. The method according to claim 1, wherein the predetermined event is an optical event associated with the object, wherein the instruction is reconfiguring the at least one parameter of the observation apparatus.

24. The method according to claim 23, wherein the observation apparatus further comprises a carrier carrying the object, wherein the optical event associated with the object is a degree of water stagnancy on the object on the carrier.

25. The method according to claim 23, wherein the optical event associated with the object is a color of the object.

26. The method according to claim 17, wherein the at least one parameter of the observation apparatus comprises at least one of a brightness of a light source of the image sensor, a capturing angle of the image sensor, a magnification of the image sensor, a pixel number to capture the image set of the object and a distance between the carrier and the image sensor.

27. The method according to claim 17, wherein the observation apparatus further comprises an image capture auxiliary, wherein the instruction is reconfiguring a color of the image capture auxiliary.

28. The method according to claim 27, wherein the carrier is between the image sensor and the image capture auxiliary.

29. The method according to claim 1, wherein the observation apparatus further comprises a carrier carrying the object, wherein the predetermined event is an optical event set comprising a first optical event associated with the carrier and a second optical event associated with the object, wherein the instruction is reconfiguring the at least one parameter of the observation apparatus.

30. The method according to claim 29, wherein the observation apparatus further comprises an image capture auxiliary, wherein the second optical event associated with the object is a first color of the object, wherein the instruction is reconfiguring a second color of the image capture auxiliary.

31. A method for optimizing first data from an image set of feed observed in an observation apparatus by reconfiguring at least one parameter of the observation apparatus, wherein the feed is used to be eaten by an aquatic animal set living below a water surface, wherein the observation apparatus comprises an image sensor above the water surface and a carrier carrying the feed, wherein the feed on the carrier and the carrier are moved from a first level above the water surface to a second level below the water surface in a first duration, and the feed on the carrier and the carrier are moved from the second level below the water surface to a third level above the water surface in a second duration, wherein the image set of the feed is captured by the image sensor when the feed is at the third level above the water surface, the method comprising:
detecting, by a processing unit, a predetermined event based on second data, wherein the second data is associated with the image set of the feed; and
determining, by the processing unit, an execution of an instruction based on the predetermined event, wherein the instruction comprises a reconfiguration message which reconfigures the at least one parameter of the observation apparatus corresponding to the execution of the instruction.

32. The method according to claim 31, wherein the predetermined event is a sinking status of the feed below the water surface in a third duration when the feed and the carrier above the water surface are moved below the water surface, wherein the instruction is controlling a moving parameter of the carrier.

33. The method according to claim 32, wherein the sinking status of the feed is determined relative to a movement of the carrier.

34. The method according to claim 31, wherein the predetermined event is an amount of the feed at the first level above the water surface, wherein the instruction is controlling a volume of a fluid combined with the feed at the first level above the water surface, wherein the feed has a first density and the fluid has a second density more than the first density.
